(19) United States
(12) Patent Application Publication
(10) Pub. No.: US 2008/0108522 A1
(43) Pub. Date: May 8, 2008

(54) Use of anionic surfactants as hydration aid for fracturing fluids

(75) Inventor: Paul Scott Carman, Spring, TX (US)

Correspondence Address: HOWREY LLP, C/O IP DOCKETING DEPARTMENT, 2941 FAIRVIEW PARK DRIVE , Suite 200, FALLS CHURCH, VA, 22042, US

(73) Assignee: BJ Services Company, Houston, TX (US)

(21) Appl. No.: 11/593,924

(22) Filed: Nov. 7, 2006

(51) Int. Cl. C09K 8/00

(52) U.S. Cl. 507/214; 507/211

(57) ABSTRACT

A composition for treating wellbore formations is provided consisting of a hydratable polysaccharide, an anionic surfactant, and an aqueous solvent where the hydratable polysaccharide is soluble in the aqueous solvent. The concentration of the anionic surfactant is sufficient to scavenge greater than about 50%, and preferably greater than 90% of the cations contained in the aqueous solvent. The hydratable polysaccharide is preferably anionic and may be a guar, guar derivative, galactomannan, cellulose, or cellulose derivative. The composition may also be a slurry used for preparing aqueous well treatment fluid. A method is also provided for utilizing the composition for fracturing a formation by pumping the fluid into the formation.

### BACKGROUND OF THE INVENTION

The invention relates to fracturing fluids, and in particular, a composition and method for improving the hydration and viscosity performance of fracturing fluids.

Subterranean formations in oil and gas wells are often treated to improve their production rates. Hydraulic fracturing operations can be performed, wherein a viscous fluid is injected into the well under pressure which causes cracks and fractures in the well. This, in turn, can improve the production rates of the well. The viscosity of the fracturing fluid can generally be any viscosity, and may be selected depending on the particular conditions encountered. The viscosity can be at least about 100 cP at 40 sec⁻¹, at least about 150 cP at 40 sec⁻¹, at least about 200 cP at 40 sec⁻¹, at least about 250 cP at 40 sec⁻¹, or at least about 300 cP at 40 sec⁻¹, or any range between any of two of these values. Viscosities can be measured using a Fann 50C Rheometer or equivalent using procedures as defined in API RP 13M or ISO-13503-1.

Fracturing fluids typically contain a liquid solvent, one or more biodegradable polymers, and a crosslinking agent. Derivatized polymers such as guar, guar derivatives, galactomannans, cellulose, and cellulose derivatives (e.g. hydroxypropyl guar and hydroxyethyl cellulose) are typically used today. Proppant materials are also commonly included with the fracturing fluid in order to prevent the fractures from collapsing once the hydraulic fracturing operation is complete.

The solvent can generally be any liquid in which the respective polymers will solubilize. An aqueous fracturing fluid is prepared by blending a hydratable or water-dispersible polymer with an aqueous fluid. The aqueous fluid can be, for example, water, brine, or water-alcohol mixtures. Any suitable mixing apparatus may be used for this procedure. In the case of batch mixing, the hydratable polymer and aqueous fluid are blended for a period of time that is sufficient to form a hydrated solution.

A suitable crosslinking agent can be any compound that increases the viscosity of the fracturing fluid by chemical crosslinking, physical crosslinking, or any other mechanisms. For example, the gellation of a hydratable polymer can be achieved by crosslinking the polymer with metal ions including aluminum, antimony, zirconium, and titanium containing compounds. The polymers are also frequently crosslinked with metal ions such as borate, titanate, or zirconate salts.

Fracturing fluids may further comprise a breaking agent or a breaker. The term “breaking agent” or “breaker” refers to any chemical that is capable of reducing the viscosity of a gelled fluid. As described above, after a fracturing fluid is formed and pumped into a subterranean formation, it is generally desirable to convert the highly viscous gel to a lower viscosity fluid. This allows the fluid to be easily and effectively removed from the formation and to allow desired material, such as oil or gas, to flow into the well bore. This reduction in viscosity of the treating fluid is commonly referred to as “breaking”.

Both organic oxidizing agents and inorganic oxidizing agents have been used as breaking agents. Examples of organic breaking agents include organic peroxides, and the like. Examples of inorganic breaking agents include persulfates, percarbonates, perborates, peroxides, chlorites, hypochlorites, oxides, perphosphates, permanganates, etc. Specific examples of inorganic breaking agents include ammonium persulfates, alkali metal persulfates, alkali metal percarbonates, alkali metal perborates, alkaline earth metal persulfates, alkaline earth metal percarbonates, alkaline earth metal perborates, alkaline earth metal peroxides, alkaline earth metal perphosphates, zinc salts of peroxide, perphosphate, perborate, and percarbonate, alkali metal chlorites, alkali metal hypochlorites, KBrO₃, KClO₃, KIO₃, sodium persulfate, potassium persulfate, and so on. Additional suitable breaking agents are disclosed in U.S. Pat. No. 5,877,127; No. 5,649,596; No. 5,669,447; No. 5,624,886; No. 5,106,518; No. 6,162,766; and No. 5,807,812. In addition, enzymatic breakers may also be used in place of or in addition to a non-enzymatic breaker. Examples of suitable enzymatic breakers are disclosed, for example, in U.S. Pat. No. 5,806,597 and No. 5,067,566. A breaking agent or breaker may be used as is or be encapsulated and activated by a variety of mechanisms including crushing by formation closure or dissolution by formation fluids. Such techniques are disclosed, for example, in U.S. Pat. No. 4,506,734; No. 4,741,401; No. 5,110,486; and No. 3,163,219.

Proppant materials are also commonly included with the fracturing fluid in order to prevent the fractures from collapsing once the hydraulic fracturing operation is complete. Examples of suitable proppants include quartz sand grains, glass and ceramic beads, walnut shell fragments, aluminum pellets, nylon pellets, and the like. Proppants are typically used in concentrations between about 1 to 8 pounds per gallon (about 0.1 to about 1 kg/l) of a fracturing fluid, although higher or lower concentrations may also be used as desired.

Because of improvements in fracturing fluid technology, polymer loadings have decreased while maintaining optimal formation fracture. However, with this reduction in polymer concentration, water/solvent quality has become very crucial to the performance of the fracturing operation. The increased use of anionic polymers, such as hydroxypropyl guar, carboxymethyl guar, and carboxymethyl hydroxylpropyl guar, for example, has made the polymers susceptible to very small concentrations of cations in the water. These cations can form soaps of the polymer that impede or prevent hydration, ultimately resulting in lower fluid viscosity and reduced formation fracture.

What is needed is an improved method for preparing an aqueous fracturing fluid in a water-based solvent containing cations.

### SUMMARY OF THE INVENTION

A composition for treating wellbore formations is provided consisting of a hydratable polysaccharide, an anionic surfactant, and an aqueous solvent where the hydratable polysaccharide is soluble in the aqueous solvent. The concentration of the anionic surfactant is sufficient to scavenge greater than about 50%, more preferably greater than 90%, and most preferably greater than 95% of the cations contained in the aqueous solvent. The concentration of the anionic surfactant is between about 1.0 and about 3.0 gallons per thousand gallons of the composition, and preferably between about 1.25 and about 2.0 gallons per thousand gallons of the composition. The anionic surfactant can be any suitable anionic surfactant or amphoteric surfactant exhibiting an anionic charge, but is preferably dodecylbenzene sulfonic acid or sodium dioctyl sulfosuccinate. The hydratable polysaccharide is preferably anionic and may be a guar, guar derivative, galactomannan, cellulose, or cellulose derivative. The composition may also be a slurry used for preparing aqueous well treatment fluid. A method is also provided for utilizing the composition for fracturing a formation by pumping the fluid into the formation.

### DESCRIPTION OF THE FIGURES

The following FIGURE is included to further demonstrate certain aspects of the present invention. The invention may be better understood by reference to this FIGURE in combination with the detailed description of specific embodiments presented herein.

FIG. 1 Hydration curves for linear gel system having a high yield carboxymethyl guar polymer and an anionic surfactant as described in Examples 1-3.

### DETAILED DESCRIPTION OF THE INVENTION

Embodiments of the present invention provide aqueous well stimulation fluids and methods of making and using the well stimulation fluids to treat subterranean formations. The well stimulation fluids can be used in hydraulic fracturing applications and for applications other than hydraulic fracturing, such as gravel packing operations, water blocking, temporary plugs for purposes of wellbore isolation and/or fluid loss control, etc. Most fracturing fluids are aqueous based, although non-aqueous fluids may also be formulated and used by applying the teachings of the present application to the preparation of slurries.

While compositions and methods are described in terms of “comprising” various components or steps (interpreted as meaning “including, but not limited to”), the compositions and methods can also “consist essentially of” or “consist of” the various components and steps, such terminology should be interpreted as defining essentially closed-member groups.

An aqueous fracturing fluid in accordance with the teachings of the present invention may be prepared by blending a hydratable or water-dispersible polymer with an aqueous fluid. The aqueous fluid is, for example, water, brine, or water-alcohol mixtures. Suitable hydratable polymers include any of the hydratable polysaccharides which are capable of forming a gel in the presence of a crosslinking agent and have anionic groups to the polymer backbone. For instance, suitable hydratable polysaccharides include anionically substituted galactomannan gums, guars, and cellulose derivatives. Specific examples are anionically substituted guar gum, guar gum derivatives, locust bean gum, Karaya gum, carboxymethyl cellulose, carboxymethyl hydroxyethyl cellulose, and hydroxyethyl cellulose substituted by other anionic groups. More specifically, suitable polymers include carboxymethyl guar, carboxyethyl guar, carboxymethyl hydroxypropyl guar, and carboxymethyl hydroxyethyl cellulose. Additional hydratable polymers may also include sulfated or sulfonated guars, cationic guars derivatized with agents such as 3-chloro-2-hydroxypropyl trimethylammonium chloride, and synthetic polymers with anionic groups, such as polyvinyl acetate, polyacrylamides, poly-2-amino-2-methyl propane sulfonic acid, and various other synthetic polymers and copolymers. Moreover, U.S. Pat. No. 5,566,760 discloses a class of hydrophobically modified polymers for use in fracturing fluids. These hydrophobically modified polymers may be used in embodiments of the invention with or without modification. Other suitable polymers include those known or unknown in the art.

In the preferred embodiments of the present invention, hydroxypropyl guar (HPG), carboxymethyl guar (CMG) and carboxymethyl hydroxypropyl guar (CMHPG) may be utilized. Because CMG and CMHPG have very strong anionic (or negative charge) because of the anionic hydroxypropyl and carboxymethyl groups, these polymers are susceptible to very small concentrations of cations in the aqueous solvent. Cations in the aqueous solvent can form soaps of the polymers and prevent full hydration, resulting in less apparent viscosity.

It has been discovered, and is thus a key aspect of the present invention, to include in the aqueous fracturing fluid an anionic surfactant to increase the overall hydration yield, and thus to increase the apparent viscosity of the fracturing fluid. It has been discovered that by using anionic surfactants to scavenge a majority of the cations in the aqueous solvent solution, the guar polymer yields better hydration. Furthermore, it has been discovered that, since the anionic surfactant is of like charge with the anionic hydroxypropyl and/or carboxymethyl groups of the guar polymer, the anionic surfactant repels the guar polymer and enhances its ability to unfold, also resulting in improved hydration. The concentration of the anionic surfactant in the fracturing fluid is preferably sufficient to scavenge greater than about 50% of the cations contained in the aqueous solvent, and more preferably sufficient to scavenge greater than about 90% of the cations contained in the aqueous solvent, and most preferably sufficient to scavenge greater than about 95% of the cations contained in the aqueous solvent. Accordingly, the concentration of the anionic surfactant is between about 1.0 and about 3.0 gallons per thousand gallons of the fracturing fluid, and most preferably between about 1.25 and about 2.0 gallons per thousand gallons of the fracturing fluid. One of ordinary skill in the art will appreciate that the optimal concentration of the anionic surfactant will depend upon many factors, including but not limited to the cation concentration present in the aqueous solvent selected for the fracturing fluid, as well as the nature of the specific anionic surfactant selected for the fracturing fluid. For example, sodium dioctyl sulfosuccinate (SDOSS) contains two anionic tails as compared to dodecylbenzene sulfonic acid (DDBSA), which only contains one anionic tail. One of ordinary skill in the art will appreciate that amphoteric surfactants, such as sulfobetains for example, may act as an anionic surfactant at certain pH, and may be utilized according to the teachings of the present invention.

A fracturing fluid in accordance with the teachings of the present invention can be created by any means known to one of skill in the art. It has been discovered that the sequence of addition of anionic surfactant or anionic polymer without affecting the qualities and properties of the fracturing fluids described herein. The fracturing fluid can be batch mixed or mixed on a continuous basis (e.g a continuous stirred tank reactor such as a blender may be used so that as the mixture is prepared it is introduced into a borehole).

Furthermore, one of ordinary skill in the art will understand that the fracturing fluids of the present invention may be blended as a slurry that is metered into the aqueous solvent at the job site, without affecting the qualities and properties of the fracturing fluids described herein. The pre-prepared slurry may include, for example, the hydratable polysaccharide, the anionic surfactant, and other constituents of the fluid, including, without limitation, crosslinkers, proppant, and breakers. The slurry composition typically contains from about 2% vol. to about 10% vol. free solvent, such as diesel or an environmentally friendly oil. The hydratable polysaccharide concentration in the slurry is preferably between about 10 pounds to about 100 pounds per thousand gallons of slurry, and most preferably about 20 pounds to about 75 pounds per thousand gallons. The slurry is typically metered into the aqueous solvent at a loading of between about 5 gallons to about 10 gallons of slurry in about 1000 gallons of aqueous solvent, such as tap water.

The following examples are included to demonstrate preferred embodiments of the invention. It should be appreciated by those of skill in the art that the techniques disclosed in the examples which follow represent techniques discovered by the inventors to function well in the practice of the invention. However, those of skill in the art should, in light of the present disclosure, appreciate that many changes can be made in the specific embodiments which are disclosed and still obtain a like or similar result without departing from the scope of the invention.

### EXAMPLE 1

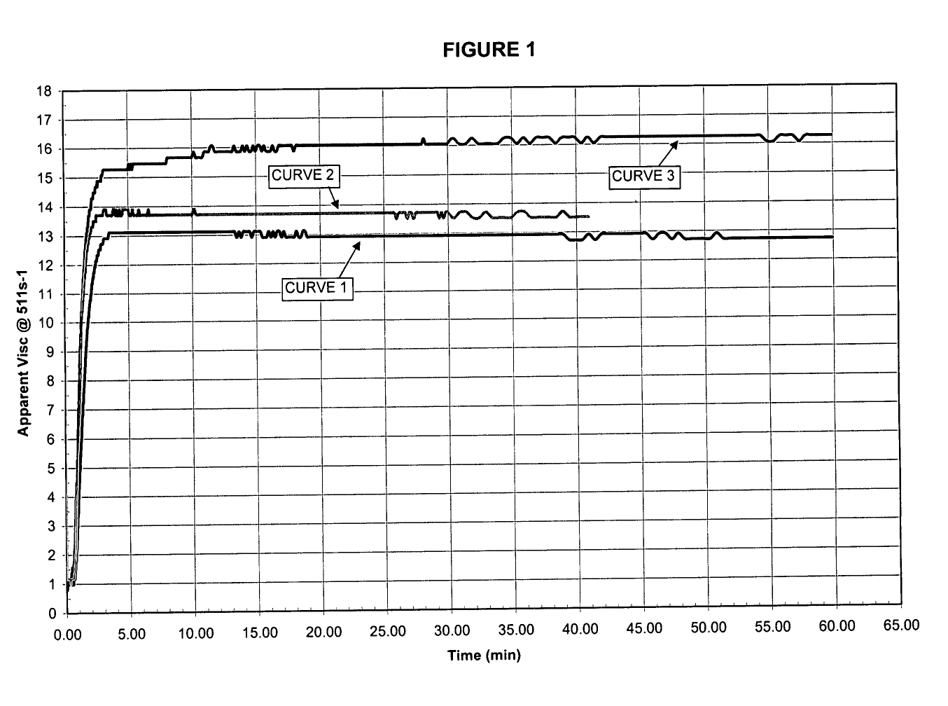

The dynamic hydration, measured by apparent viscosity over time, of three fracturing fluids is illustrated in FIG. 1. Curve 1 illustrates the dynamic hydration for an aqueous fracturing fluid comprising 18 pptg (pounds per thousand gallons) CMG and 0.25 ppt (pounds per thousand pounds) FE-110 in tap water from Tomball, Tex. The viscosity data of curve 1 was generated using an M3500 Viscometer, manufactured by Grace Instrument Company of Houston, Tex., at 300 rpm and a shear rate of 511 s⁻¹ at 73° F. As shown, curve 1 demonstrated a sustained viscosity of approximately 13 cp viscosity after three minutes.

### EXAMPLE 2

Curve 2 illustrates the dynamic hydration for an aqueous fracturing fluid comprising 18 pptg CMG, 0.25 pptg FE-110, and 1.5 gpt (gallons per thousand gallons) dodecylbenzene sulfonic acid (DDBSA) in tap water from Tomball, Tex. DDBSA is a commonly used industrial anionic surfactant that is commercially available from many vendors. As in Example 1, the viscosity data of curve 2 was generated using an M3500 Viscometer, manufactured by Grace Instrument Company of Houston, Tex., at 300 rpm and a shear rate of 511 s⁻¹ at 73° F. As shown, curve 1 demonstrated a sustained viscosity of greater than 13.7 cp after two minutes. Additionally, further testing revealed that the presence of the DDBSA had no effect on the ultimate viscosity of the fracturing fluid after crosslinking the CMG.

### EXAMPLE 3

Curve 3 illustrates the dynamic hydration for an aqueous fracturing fluid comprising 18 pptg CMG, 0.25 pptg FE-110, and 1.5 gpt Aerosol® OT-75 PG in tap water from Tomball, Tex. Aerosol® OT-75 PG is an ionic surfactant marketed by Cytec Industries Inc. of West Paterson, N.J., containing 75% by weight sodium dioctyl sulfosuccinate (SDOSS) in a water/propylene glycol solvent. As in Examples 1 and 2, the viscosity data of curve 3 was generated using an M3500 Viscometer, manufactured by Grace Instrument Company of Houston, Tex., at 300 rpm and a shear rate of 511 s⁻¹ at 73° F. As shown, curve 3 demonstrated a sustained viscosity of greater than 15.0 cp after three minutes, and a sustained viscosity of greater than 16.0 cp after fifteen minutes. As with DDBSA in Example 2, further testing revealed that the presence of the SDOSS had no effect on the ultimate viscosity of the fracturing fluid after crosslinking the CMG.

### Methods of Use

The above-described compositions can be used to treat and/or fracture a downhole well formation, as would be apparent to one of ordinary skill in the art. Accordingly, an additional embodiment of the present invention is directed to methods for fracturing a downhole well formation. During hydraulic fracturing, a fracturing fluid in accordance with the present invention is injected into a well bore under high pressure. Once the natural reservoir pressures are exceeded, the fracturing fluid initiates a fracture in the formation which generally continues to grow during pumping. The treatment design generally requires the fluid to reach a maximum viscosity as it enters the fracture which affects the fracture length and width, although the viscosity of the fracturing fluid must be high enough for the fluid to adequately transport the proppant from the surface to the fracture. Crosslinking agents, such as borate, titanate, or zirconium ions, can further increase the viscosity of the fracturing fluid. Proppants remain in the produced fracture to prevent the complete closure of the fracture and to form a conductive channel extending from the well bore into the formation being treated once the fracturing fluid is recovered. As discussed herein, the fracturing fluid of the present invention minimizes formation of the soaps of the polymer that impede or prevent hydration, and is thus useful in producing optimal fluid viscosity and increased formation fracture.

It should be understood that the above-described method is only one way to carry out embodiments of the invention. The following U.S. Patents disclose various techniques for conducting hydraulic fracturing which may be employed in embodiments of the invention with or without modifications: U.S. Pat. Nos. 7,067,459; 7,049,436; 7,012,044; 7,007,757; 6,875,728; 6,844,296; 6,767,868; 6,491,099; 6,468,945; 6,169,058; 6,135,205; 6,123,394; 6,016,871; 5,755,286; 5,722,490; 5,711,396; 5,674,816; 5,551,516; 5,497,831; 5,488,083; 5,482,116; 5,472,049; 5,411,091; 5,402,846; 5,392,195; 5,363,919; 5,228,510; 5,074,359; 5,024,276; 5,005,645; 4,938,286; 4,926,940; 4,892,147; 4,869,322; 4,852,650; 4,848,468; 4,846,277; 4,830,106; 4,817,717; 4,779,680; 4,479,041; 4,739,834; 4,724,905; 4,718,490; 4,714,115; 4,705,113; 4,660,643; 4,657,081; 4,623,021; 4,549,608; 4,541,935; 4,378,845; 4,067,389; 4,007,792; 3,965,982; and 3,933,205.

All of the compositions and/or methods disclosed and claimed herein can be made and executed without undue experimentation in light of the present disclosure. While the compositions and methods of this invention have been describe din terms of preferred embodiments, it will be apparent to those of skill in the art that variations may be applied to the compositions and/or methods and/or in the sequence of the steps of the methods described herein without departing from the concept and scope of the invention. More specifically, it will be apparent that certain agents which are chemically related may be substituted for the agents described herein while the same or similar results would be achieved. All such similar substitutes and modifications apparent to those skilled in the art are deemed to be within the scope and concept of the present invention.

What is claimed is:

1. A composition for use in treating wellbore formations, comprising:
a hydratable polysaccharide;
an anionic surfactant; and
an aqueous solvent;
wherein the hydratable polysaccharide is soluble in the aqueous solvent.

2. The composition of claim 1, wherein the concentration of the anionic surfactant is sufficient to scavenge greater than about 50% of the cations contained in the aqueous solvent.

3. The composition of claim 1, wherein the concentration of the anionic surfactant is sufficient to scavenge greater than about 90% of the cations contained in the aqueous solvent.

4. The composition of claim 1, wherein the concentration of the anionic surfactant is sufficient to scavenge greater than about 95% of the cations contained in the aqueous solvent.

5. The composition of claim 1, wherein the concentration of the anionic surfactant is between about 1.0 and about 3.0 gallons per thousand gallons of the composition.

6. The composition of claim 1, wherein the concentration of the anionic surfactant is between about 1.25 and about 2.0 gallons per thousand gallons of the composition.

7. The composition of claim 1, wherein the anionic surfactant is dodecylbenzene sulfonic acid.

8. The composition of claim 1, wherein the anionic surfactant is sodium dioctyl sulfosuccinate.

9. The composition of claim 1, wherein the anionic surfactant is an amphoteric surfactant exhibiting anionic charge.

10. The composition of claim 1, wherein the aqueous solvent comprises tap water.

11. The composition of claim 1, wherein the aqueous solvent comprises brine.

12. The composition of claim 1, wherein the aqueous solvent comprises a water-alcohol mixture.

13. The composition of claim 1, wherein the hydratable polysaccharide is selected from the group consisting of guars, guar derivatives, galactomannans, celluloses, and cellulose derivatives.

14. The composition of claim 1, wherein the hydratable polysaccharide selected from the group consisting of hydroxypropyl guar, carboxymethyl guar, and carboxymethyl hydroxypropyl guar.

15. The composition of claim 1, wherein the hydratable polysaccharide is anionic.

16. The composition of claim 1, wherein the composition is a slurry used in the preparation of an aqueous well treatment fluid.

17. A method for fracturing a formation comprising:
providing a fluid comprising:
a hydratable polysaccharide,
an anionic surfactant, and
an aqueous solvent,
wherein the hydratable polysaccharide is soluble in the aqueous solvent.
pumping the fluid into the formation.

18. The method of claim 17, wherein the concentration of the anionic surfactant is sufficient to scavenge greater than about 90% of the cations contained in the aqueous solvent.

19. The method of claim 17, wherein the concentration of the anionic surfactant is between about 1.25 and about 2.0 gallons per thousand gallons of the fluid.

20. The method of claim 17, wherein the anionic surfactant is dodecylbenzene sulfonic acid.

21. The method of claim 17, wherein the anionic surfactant is sodium dioctyl sulfosuccinate.

22. The method of claim 17, wherein the aqueous solvent comprises tap water.

23. The method of claim 17, wherein the hydratable polysaccharide is selected from the group consisting of hydroxypropyl guar, carboxymethyl guar, and carboxymethyl hydroxypropyl guar.

24. The method of claim 17, wherein the hydratable polysaccharide is anionic.

25. A method for preparing an aqueous well treatment fluid, comprising:
providing a slurry comprising:
a hydratable polysaccharide, and
an anionic surfactant; and
metering the slurry into an aqueous solvent to form the aqueous well treatment fluid.

26. The method of claim 25, wherein the hydratable polysaccharide concentration in the slurry is between about 10 pounds to about 100 pounds per thousand gallons.

27. The method of claim 25, wherein the hydratable polysaccharide in the non-aqueous slurry is between about 20 pounds to about 75 pounds per thousand gallons.

28. The method of claim 25, wherein the slurry is metered into the aqueous solvent at a loading of between about 5 gallons to about 10 gallons of slurry in about 1000 gallons of water.

29. The method of claim 25, wherein the slurry composition contains from about 2% vol. to about 10% vol. free solvent.
